(19) United States
(12) Patent Application Publication
(10) Pub. No.: US 2008/0203059 A1
(43) Pub. Date: Aug. 28, 2008

(54) DILUTABLE CMP COMPOSITION CONTAINING A SURFACTANT

(75) Inventors: Francesco De Rege Thesauro, Naperville, IL (US); Jason Keleher, Aurora, IL (US)

Correspondence Address: STEVEN WESEMAN;ASSOCIATE GENERAL COUNSEL, I.P., CABOT MICROELECTRONICS CORPORATION, 870 NORTH COMMONS DRIVE, AURORA, IL, 60504, US

(73) Assignee: Cabot Microelectronics Corporation, Aurora, IL (US)

(21) Appl. No.: 11/679,273

(22) Filed: Feb. 27, 2007

(51) Int. Cl. B44C 1/22

(52) U.S. Cl. 216/89; 252/79.1; 252/79.4

(57) ABSTRACT

The inventive polishing composition comprises an abrasive, an aqueous medium, a surfactant in an amount above its critical micelle concentration, and a hydrophobic surface active compound. The invention also provides a method of using a polishing composition.

### BACKGROUND OF THE INVENTION

Chemical-mechanical polishing (“CMP”) is a process that is used to planarize semiconductor wafers by using physical and chemical mechanisms for polishing. In general, the CMP process involves holding a semiconductor substrate, such as a wafer, against a rotating wetted polishing pad under a controlled downward pressure. A rotating polishing head or wafer carrier is typically utilized to hold the wafer in place against the polishing pad. Both the pad and wafer are then counter-rotated while a CMP polishing composition, which typically contains surface active chemical compounds and an abrasive material, is passed between them. The wafer is chemically modified and then abraded by the polishing force exerted by the polishing pad. The abraded material is then removed from the wafer surface due to the polishing composition flow and pad rotation.

Li et al., U.S. Patent Application Publication No. 2004/0092102 A1, disclose a polishing composition for CMP wherein the composition comprises, inter alia, a micelle-forming enhancement agent, such as a surfactant, and an active agent that is chemically reactive with the substrate to enhance polishing performance. According to Li et al., a micelle can be formed in the composition to solubilize the active agent and isolate it from the substrate. The active agent is released from the micelle in response to a force applied against the substrate during polishing, i.e., the forces applied to the substrate by the polishing action of the polishing pad.

Hosali et al., U.S. Pat. No. 5,738,800, disclose a polishing composition for chemical-mechanical polishing a substrate comprised of silicon dioxide and silicon nitride. The polishing composition according to Hosali et al. comprises an aqueous medium, abrasive particles, a surfactant, and a complexing agent. The surfactant used in conjunction with the complexing agent in the polishing composition according to Hosali et al. does not perform the usual function of surfactants (i.e., the stabilization of the particulate dispersion), but rather it is believed by the inventors to affect the rate of removal of silicon nitride from the composite surface.

Edelbach et al., U.S. Pat. No. 6,616,514, disclose a polishing composition for CMP for selectively removing silicon dioxide from a surface of a substrate in preference to silicon nitride. The polishing composition according to Edelbach et al. includes an abrasive, an aqueous medium, and an organic polyol, wherein the organic polyol performs the function of suppressing the rate of removal of silicon nitride during CMP.

Despite the foregoing polishing compositions and methods, there remains a need for other polishing compositions and methods of using the same, especially more economic and/or efficient polishing compositions and methods, wherein the polishing composition exhibits desirable properties such as a concentrated form, which includes stable and cheap reagents, capable of inhibiting polishing on specific substrate surfaces, and important hydrophobic components, and a polishing composition capable of dual functional polishing applicable to a wide variety of substrate surfaces.

### BRIEF SUMMARY OF THE INVENTION

The invention provides a polishing composition comprising (a) an abrasive, wherein the abrasive is present in an amount of 18 wt. % or more of the polishing composition, (b) an aqueous medium, (c) a surfactant, wherein the surfactant is present in an amount above its critical micelle concentration, and (d) a hydrophobic surface active compound.

The invention also provides a method of using a polishing composition, which method comprises (i) providing a polishing composition comprising (a) an abrasive, wherein the abrasive is present in an amount of 18 wt. % or more of the polishing composition, (b) an aqueous medium, and (c) a surfactant, wherein the surfactant is present in an amount above its critical micelle concentration, and (ii) diluting the polishing composition,

### BRIEF DESCRIPTION OF THE SEVERAL VIEWS OF THE DRAWING(S)

FIG. 1 is a graph of tantalum removal rate versus surfactant carbon chain length.

FIG. 2 is a graph of tantalum removal rate versus amount of ammonium lauryl sulfate.

FIG. 3 is a graph of copper removal rate as a function of the amounts of surfactant versus benzotriazole versus tryptophan.

FIG. 4 is a graph of surface tension versus amount of surfactant versus tantalum removal rate and tetraethylorthosilicate removal rate.

### DETAILED DESCRIPTION OF THE INVENTION

The invention provides a polishing composition. The polishing composition comprises (a) an abrasive, (b) an aqueous medium, (c) a surfactant, wherein the surfactant is present in an amount above its critical micelle concentration, and (d) a hydrophobic surface active compound.

Any suitable abrasive can be used. Suitable abrasives include, for example, alumina, ceria, copper oxide, iron oxide, nickel oxide, manganese oxide, silica, silicon nitride, silicon carbide, tin oxide, titania, titanium carbide, tungsten oxide, yttrium oxide, and/or zirconia. The abrasive preferably is a metal oxide, such as silica, which, for example, can be precipitated silica or condensation-polymerized silica (e.g., which typically is prepared by condensing Si(OH)₄ to form colloidal particles). The abrasive can be in any suitable form and preferably is substantially spherical.

The polishing composition desirably is in a concentrate form, such that it is diluted prior to use in polishing a substrate. In particular, the abrasive is present in an amount of 18 wt. % or more of the polishing composition (e.g., 20 wt. % or more, 24 wt. % or more, 27 wt. % or more, or 30 wt. % or more). The abrasive typically will be present in an amount of 30 wt. % or less of the polishing composition (29 wt. % or less, 25 wt. % or less, or 22 wt. % or less). Preferably, the abrasive is present in an amount of 18 wt. % to 30 wt. % of the polishing composition.

The abrasive desirably is suspended in the polishing composition, more specifically in the aqueous medium component of the polishing composition. When the abrasive is suspended in the polishing composition, the abrasive preferably is colloidally stable. The term colloid refers to the suspension of abrasive particles in the liquid carrier. Colloidal stability refers to the maintenance of that suspension over time. In the context of this invention, an abrasive is considered colloidally stable if, when the abrasive is placed into a 100 ml graduated cylinder and allowed to stand unagitated for a time of 2 hours, the difference between the concentration of particles in the bottom 50 ml of the graduated cylinder ([B] in terms of g/ml) and the concentration of particles in the top 50 ml of the graduated cylinder ([T] in terms of g/ml) divided by the initial concentration of panicles in the abrasive composition ([C] in terms of g/mil) is less than or equal to 0.5 (i.e., {[B]-[T]}/[C]≦0.5). The value of [B]-[T]/[C] desirably is less than or equal to 0.3, and preferably is less than or equal to 0.1.

The aqueous medium can be any suitable aqueous medium. The aqueous medium desirably comprises, consists essentially of, or consists of water, preferably, de-ionized water.

The surfactant can be any suitable surfactant. Suitable surfactants include, for example, anionic surfactants, cationic surfactants, Zwitterionic surfactants, nonionic surfactants, and combinations thereof. The surfactant comprises a head group (“A”) and a tail group (“B”).

The anionic surfactants include those surfactants where A is one or more linked anionic groups, including carboxylate, sulfonate, sulfate, phosphate, or phosphonate. The anionic surfactants also include those surfactants where B is a hydrophobic group, including alkyl, aryl, or a mixture thereof. B may also include elements other than carbon and hydrogen, so long as B remains hydrophobic.

Typical examples of anionic surfactants include carboxylates, such as soaps (containing the general structure RCOO⁻M⁺, where R is a straight hydrocarbon chain in the C₉-C₂₁ range and M⁺ is a metal or ammonium ion), and polyalkoxycarboxylates; sulfonates, such as alkylbenzenesulfonates, alkylarenesulfonates, napthalenesulfonates, α-olefinsulfonates, sulfonates with ester, amide, or ether linkages including amidosulfonates, 2-sulfoethyl esters of fatty acids, and fatty acid ester sulfonates; sulfates, such as alcohol sulfates, ethoxylated and sulfated alcohols, ethoxylated and sulfated alkylphenols, sulfated acids, sulfated amides, sulfated esters, and sulfated natural oils and fats; phosphate esters, such as butyl phosphate, hexyl phosphate, 2-ethylhexyl phosphate, octyl phosphate, decyl phosphate, oxtyldecyl phosphate, mixed alkyl phosphate, hexyl polyphosphate, octyl polyphosphate, glycerol monoester of mixed fatty acids (phosphated), 2-ethylhexanol (ethoxylated and phosphated), deodecyl alcohol (ethoxylated and phosphated), tridecyl alcohol (branched), 9-octadecenyl alcohol (ethoxylated and phosphated), polyhydric alcohols (ethoxylated and phosphated), phenol (ethoxylated and phosphated), octylphenol (ethoxylated and phosphated), nonylphenol (ethoxylated and phosphated), dodecylphenol (ethoxylated and phosphated), and dinonylphenol (ethoxylated and phosphated); and phosphonate esters. Preferably, the anionic surfactant comprises a sulfonate group,

The cationic surfactants include those surfactants where A is one or more linked cationic groups, including amine or substituted amine, such as ammonium salts or NR′R″ R′″, where R′, R″, and R′″ independently can be an organic alkyl, aryl, or hydrogen. The cationic surfactants also include those surfactants where B is a hydrophobic group, including alkyl, aryl, or a mixture thereof. B may also include elements other than carbon and hydrogen, so long as B remains hydrophobic.

Typical examples of cationic surfactants include amines, such as oxygen-free amines including mono-, di-, and polyamines, oxygen-containing amines including amine oxides, ethoxylated alkylamines, 1-(2-hydroxyethyl)-2-imidazolines, and alkoxylates of ethylenediamine, ethylenediamine alkoxylates, and amines with amide linkages; and quaternary ammonium salts, such as dialkyldimethylammonium salts, alkylbenzyldimethylammonium chlorides, alkyltrimethylammonium salts, alkylpyridinium halides, and quaternary ammonium esters.

The Zwitterionic surfactants include those surfactants where A is made by linking one or more of the above-listed anionic A groups with one or more of the above-listed cationic A groups. The Zwitterionic surfactants also include those surfactants where B is a hydrophobic group, including alkyl, aryl, or a mixture thereof. B may also include elements other than carbon and hydrogen, so long as B remains hydrophobic.

Typical examples of Zwitterionic surfactants include alkylbetaines, amidopropylbetaines, alkyldimethylamines, imidazolinium derivatives, and amino acids and their derivatives.

The nonionic surfactants include those surfactants where A is one or more hydroxyl or polyethylene oxide groups. The nonionic surfactants also include those surfactants where B is a hydrophobic group, including alkyl, aryl, or a mixture thereof. B may also include elements other than carbon and hydrogen, so long as B remains hydrophobic.

Typical examples of nonionic surfactants include carboxylic acid esters, such as glycerol esters and polyoxyethylene esters; anhydrosorbitol esters, such as ethoxylated anhydrosorbitol esters; polyoxyethylene surfactants, such as alcohol ethoxylates and alkylphenol ethoxylates; natural ethoxylated fats, oils and waxes; glycol esters of fatty acids; alkyl polyglycosides; carboxylic amides, such as diethanolamine condensates, monoalkanolamine condensates including coco, lauric, oleic, and stearic monoethanolaimdes and monoisopropanolamides, and polyoxyethylene fatty acid amides; and fatty acid glucamides.

Other nonionic surfactants may include polyoxyalkylene block copolymers. The polyoxyalkylene block copolymer may be of the form A_{α}B_{β}A_{α′}, where A and B are alkylene oxide monomers such as ethylene oxide, propylene oxide, or butylene oxide, and where A and B are different monomers with different polarities. In one embodiment, the copolymer is a tri-block copolymer of polyethylene oxide and polypropylene oxide having the general formula HO(CH₂CH₂O)_{α}(CH(CH₃)CH₂O)_{β}(CH₂CH₂O)_{α′}H, where α and α′ are integers between about 2 and about 140 and β is an integer between about 50 and about 75, That is, the propylene oxide (PO) block is sandwiched between two ethylene oxide (EO) blocks as follows: EO-PO-EO. Alternatively, the copolymer may be a triblock copolymer of the form PO-EO-PO, wherein the ethylene oxide block is sandwiched between two polypropylene blocks.

Nonexclusive examples of suitable tri-block copolymers include the PLURONIC™ family of compounds commercially available from BASF Corp. (Mount Olive, N.J.). PLURONIC™ P103, P104, P105, P123, F108, F88, LiO1, and L121 compounds are suitable copolymers for use in the invention. The PLURONIC™ R family of compounds may also be used. The PLURONIC™ and PLURONIC™ R compounds have surface active agent properties because the polyethylene oxide group has a hydrophilic (“water-loving”) nature while the polypropylene oxide has a hydrophobic (“water-fearing”) nature.

It is anticipated that additional block, random, and/or random-block copolymers that have chemical properties similar to PLURONIC™ and PLURONIC™ R compounds would be suitable nonionic surfactancts as well, including certain triblock copolymers of the SYNPERONICE™ series of compounds available from Uniqema Inc., as well as similar copolymers available from Dow Chemical Company (Midland, Mich.), such as EP series block copolymers, SYNALOX™ EPB random copolymers, and SYNALOX™ PB series polyoxyalkylene copolymer.

Any suitable hydrophobic surface active compound can be used. Suitable hydrophobic surface active compounds include azole compounds such as benzimidazole-2-thiol, 2-[2-(benzothiazolyl)]thiopropionic acid, 2-[2-(benzothiazolyl)]thiobutyric acid, 2-mercaptobenizotiazole, 1,2,3-triazole, 1,2,4-triazole, 3-amino-1H-1,2,4-triazole, benzotriazole, 1-hydroxybenzotriazole, 1-dihydroxypropylbenzotriazole, 2,3-dicarboxypropylbenzotriazole, 4-hydroxybenzotriazole, 4-carboxyl-1H-benzotriazole, 4-methoxycarbonyl-1H-benzotriazole, 4-butoxycarbonyl-1H-benzotriazole, 4-octyloxycarbonyl-1H-benzotriazole, 5-hexylbenzotriazole, N-(1,2,3-benzotriazolyl-1-methyl)-N-(1,2,4-triazoly-1-1-methyl)-2-ethylhexylamine, tolyltriazole, naphthotriazole, bis[(1-benzotriazolyl)methyl]phosphate. Suitable hydrophobic surface active compounds also include amino acids which satisfy the formula H₂N—CR¹R²COOH, wherein R¹ and R² independently are hydrogen, C₁-C₃₀ alkyl, or C₆-C₃₀ aryl groups, R¹ and R² do not contain a total of less than one carbon, and R¹ and R² do not contain any charged groups. The aryl groups optionally contains one or more hetero atoms, such as N, S, O, or a combination thereof.

Other suitable hydrophobic surface active compounds include octanol, as well as compounds which have a suitable octanol-water partition coefficient (K_{OW}) namely a log K_{OW} above about 0. The log K_{OW} preferably is above about 2 or higher. A partition coefficient is the measure of the differential solubility of a compound in two solvents, Thus, the octanol-water partition coefficient is a measure of the hydrophobicity (or hydrophilicity) of a compound based on the solvents octanol and water. Suitable hydrophobic surface active compounds having a log K_{OW} above about 0 include alcohols with 3 or more carbons for every hydroxyl group. Suitable hydrophobic surface active compounds having a log K_{OW} of about 2 or higher include alcohols with 8 or more carbons for every hydroxyl group; aromatic hydrocarbons with 1 or more benzene rings, aromatic hydrocarbons with alkyl substituents, alkanes with 6 or more carbon atoms, and heterocyclic aromatic compounds such as pyridines. The log K_{OW} of a compound can be calculated from the molecular structure of the compound (C. Hansch and A. Leo, Exploring QSAR: Fundamentals and Applications in Chemistry and Biology, American Chemical Society, Washington (1995)).

The polishing composition may optionally comprise an oxidant. The oxidant can be any suitable oxidant. Suitable oxidants include per-compounds. A per-compound (as defined by Hawley's Condensed Chemical Dictionary) is a compound containing at least one peroxy group (—O—O—) or a compound containing an element in its highest oxidation state. Examples of compounds containing at least one peroxy group include, but are not limited to, hydrogen peroxide and its adducts such as urea hydrogen peroxide and percarbonates, organic peroxides such as benzoyl peroxide, peracetic acid, and di-tert-butyl peroxide, monopersulfates (SO₅²⁻), dipersulfates (S₂O₈²⁻), and sodium peroxide. Examples of compounds containing an element in its highest oxidation state include, but are not limited to, periodic acid, periodate salts, perbromic acid, perbromate salts, perchloric acid, perchlorate salts, perboric acid, perborate salts, and permanganates. Typical examples of per-compounds include hydrogen peroxide, dipersulfate, or iodate.

Other suitable oxidants include organic oxidizers. The organic oxidizers comprise an unsaturated hydrocarbon ring, an unsaturated heterocyclic ring, or a combination thereof. The organic oxidizers include oxidizers having a heterocyclic ring comprising 2 or more heteroatoms (e.g., N, O, S, or a combination thereof). The organic oxidizers also include oxidizers having a pi-conjugated ring having at least three heteroatoms (e.g., N, O, S, or a combination thereof).

Typical examples of organic oxidizers include a compound having at least one quinone moiety (e.g., an anthraquinone, a napthoquinone, a benzoquinone, and the like), a paraphenylenediamine compound, a phenazine compound, a thionine compound, a phenioxazine compound, an indophenol compound, or any combination thereof, for example, 1,4-benzoquinone, 1,4-napthoquinone, 1,2-napthoquinone, 9,10-anthroquinone, paraphenylenediamine, phenzine, thionine, phenoxazine, phenoxathiin, indigo, and indophenol.

The surfactant may be present in the polishing composition in an amount above its critical micelle concentration (“CMC”). At an amount above its CMC, the surfactant is able to form micelles, or similar organized structures, in the composition or on the substrate surface the composition is used for polishing. These micelle-like structures can be used to increase the solubility of hydrophobic compounds, which are often important surface active components of polishing compositions. The micelle-like structures provide a hydrophobic environment in the polishing composition into which the hydrophobic surface active compounds can partition. Such an environment becomes increasingly necessary upon using hydrophobic surface active compounds in polishing composition concentrates.

The polishing composition is optionally free of a complexing agent, Complexing agents are capable of complexing, e.g., chelating, with the portion of the substrate abraded from the substrate surface. Examples of complexing agents include ammonia, and organic compounds having amine and/or carboxylate groups, such as ethylenediaminetetraacetic acid, iminodiacetic acid, malonic acid, succinic acid, nitrilotriacetic acid, citric acid, oxalic acid, gamma-aminobutyric acid, acetic acid, glycine, arginine, and alanine.

The invention also provides a method of using a polishing composition. The method comprises (i) providing a polishing composition comprising (a) an abrasive, wherein the abrasive is present in an amount of 18 wt. % or more of the polishing composition, (b) an aqueous medium, and (c) a surfactant, wherein the surfactant is present in an amount above its critical micelle concentration, and (ii) diluting the polishing composition. The discussion herein concerning the aspects of the inventive polishing composition, especially the components thereof, also is applicable to the same aspects of the inventive method.

The micelle-like structures formed by the surfactant molecules are attracted to, and have the ability to form a barrier layer on, a substrate surface. Contacting a substrate with the polishing composition comprising a surfactant in an amount above its CMC causes an interaction between the surfactant and the substrate, thereby inhibiting the polishing of the substrate. For example, by contacting a substrate comprising tantalum with a polishing composition comprising a sulfonate surfactant in an amount above its CMC, the surfactant forms a barrier layer on the tantalum surface so as to inhibit the polishing of the substrate.

Various polishing compositions comprising charged surfactants in amounts above their CMC behave in a similar fashion and inhibit the polishing of a substrate that possesses an opposite charge from the surfactant. Where a polishing composition has a pH lower than the isoelectric point of the substrate, an anionic surfactant present in the polishing composition in an amount above its CMC interacts with the substrate surface and inhibits polishing of the substrate. For example, the isoelectric point for a typical substrate comprising tantalum is about pH 3.5. Therefore, below pH 3.5 the substrate will be positively charged. Anionic surfactants; for example, sulfonate surfactants, are attracted to the cationic tantalum substrate surface and form a barrier which inhibits polishing. Conversely, where a polishing composition has a pH higher than the isoelectric point of the substrate, a cationic surfactant present in the polishing composition in an amount above its CMC interacts with the substrate surface and inhibits polishing of the substrate. Nonionic surfactants also inhibit the polishing of a substrate where specific interactions exist. For example, nonionic surfactants such as ethylene oxide-propylene oxide co-polymers form a barrier layer on an oxide-containing substrate through hydrogen bonding, thereby inhibiting the polishing of the oxide-containing substrate. Further, polishing of a substrate may be inhibited where the surfactant has a charge opposite to the zeta potential charge of the substrate.

The polishing composition can be diluted with any suitable diluent or dilutant, for example, water. While the surfactant is present in the polishing composition in an amount above its CMC, the polishing composition may be used to contact a substrate and abrade a first portion of the substrate, thereby polishing the substrate. The surfactant in the polishing composition interacts with a second portion of the substrate, wherein the micelle-like structures form a barrier layer on the surface of the second portion of the substrate and inhibit (i.e., reduce but not necessarily entirely prevent) the removal of the second portion of the substrate. Dilution of the polishing composition may be limited so that the amount of the surfactant remains above its CMC.

Further dilution of the polishing composition to cause the amount of the surfactant to be below its CMC causes the micelle-like structures to break apart. The polishing composition, previously usable to inhibit the removal of a portion of the substrate, may now be used to contact the substrate and abrade the portion of the substrate, thereby polishing the substrate. The polishing composition can be diluted to cause the amount of the surfactant to be below its CMC prior to contacting a substrate. An optional second polishing composition, such as a polishing composition comprising an abrasive, in an amount of 18 wt. % or more of the polishing composition, and an aqueous medium, then can be used to contact the substrate to abrade a second portion of the substrate and thereby polish the substrate.

Polishing is modified by the presence of optional hydrophobic surface active compounds. The hydrophobic surface active compounds, which can partition in the hydrophobic environment of the micelle-like structures, may be transported to the interface between the substrate and polishing composition by the micelle-like structures, and released once the micelle-like structures break apart due to dilution. Upon their release, the hydrophobic surface active compounds are allowed to interact at the interface between the substrate and polishing composition. The polishing can be increased or decreased by the hydrophobic surface active compounds depending on the nature of their interaction with the substrate, and the dilution of the polishing composition. Meanwhile, independent of the amount of surfactant present in the polishing composition, diluting the polishing composition causes a decrease in the concentration of the optional oxidant present in the polishing composition, thereby decreasing the rate of removal of a portion of any substrate that requires an oxidant for polishing. Thus, by varying the dilution of the polishing composition, it is possible to control the removal of the first portion and second portion of the substrate and thereby control the overall polishing of the substrate.

The first and second portions of the substrate can comprise, consist essentially of, or consist of any suitable material, such as a metal, semi-metal, or a dielectric material. Suitable metals include copper, tantalum, tungsten, ruthenium, platinum, palladium, iridium, tetraethylorthosilicate, and the oxides and nitrides of these metals. Suitable semi-metal materials include silicon, polysilicon, gallium, as well as Group III/V materials such as gallium arsenide. Suitable dielectric materials include polysilicon, silicon dioxide, borosilicate glasses, silicon nitride, and carbon doped oxides. Preferably, the first portion of the substrate comprises copper, and the second portion of the substrate comprises tantalum, or vice versa.

The following examples further illustrate the invention but, of course, should not be construed as in any way limiting its scope.

### EXAMPLE 1

This example illustrates the effect of the amount of the surfactant in a polishing composition in an amount above its CMC on the rate of removal of a portion, particularly of metal, of a substrate polished with the polishing composition.

A series of polishing compositions was prepared, wherein each polishing composition contained 1 wt. % colloidal silica (Nalco particle size about 50 nm, 250 ppm aluminum doped), 0.1 wt. % 9,10-anthraquinone-1,5-disulfonic acid, 0.1 wt. % benzotriazole, and either no surfactant (which represented the control polishing composition) or 3.47 mmol of an alkyl sulfonate surfactant with differing carbon chain lengths for the alkyl group thereof. The pH of each polishing composition was adjusted to 2.2 with nitric acid or potassium hydroxide. Polishing was performed using about 10 cm (4 inch) diameter tantalum wafers on a Logitech polisher with a Polytex polishing pad.

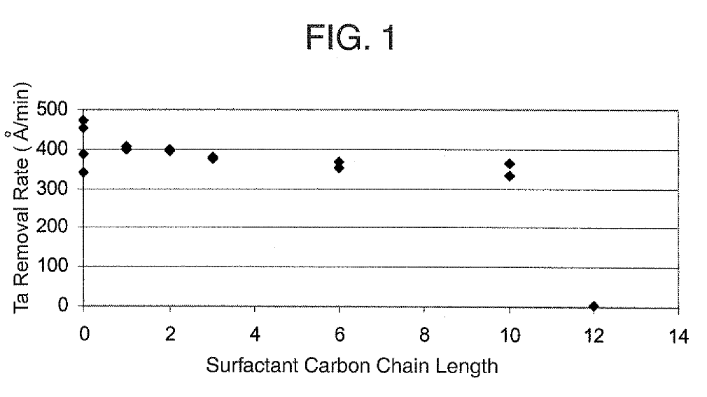

Each polishing composition was used to polish a tantalum wafer for 60 seconds, utilizing 9.3 kPa (1.35 psi) down force pressure of the tantalum wafer against the polishing pad, a platen rotational speed of 110 rpm, a head rotational speed of 102 rpm, and a polishing composition flow rate of 150 ml/min. Two tantalum wafers were used to evaluate each polishing composition, except that four tantalum wafers were used to evaluate the control polishing composition, with two tantalum wafers being used before the testing of the other polishing compositions and two tantalum wafers being used after the testing of the other polishing composition. The rate of tantalum removal (Å/min) was determined by the pre-polish and post-polish measurement of the tantalum wafers using a sheet resistance 4-point probe RS-75 metrology tool (AMAT: Santa Clara, Calif.). The tantalum removal rates were plotted against the surfactant carbon chain lengths in the graph of FIG. 1.

The tantalum removal rates for the control polishing compositions are represented in FIG. 1 as the data points corresponding to a surfactant carbon chain length of 0, wherein the pair of data points representing a higher tantalum removal rate are for the control composition tested before the testing of the other polishing compositions, and wherein the pair of data points representing a lower tantalum removal rate are for the control composition tested after the testing of the other polishing compositions.

As is apparent from the data plotted in the graph of FIG. 1, the tantalum removal rates for the polishing compositions containing the alkyl sulfonate surfactant with a carbon chain length of up to 10 are within the range of tantalum removal rates observed for the control polishing composition tested before and after the testing of the other polishing compositions. These results indicate that the presence of 3.47 mmol of the alkyl sulfonate surfactant with a carbon chain length of up to 10 in the polishing composition does not significantly affect the tantalum removal rate of the polishing composition. In contrast, the presence of the same amount of the alkyl sulfonate surfactant with a carbon chain length of above 10 reduced the tantalum removal rate of the polishing composition (i.e., inhibited tantalum polishing).

Since the CMC is directly and inversely related to the alkyl chain length of anionic surfactants, it is believed that the surfactant concentration of 3.47 mmol is above the CMC only for the alkyl sulfonate surfactant with an alkyl chain containing more than 10 carbon atoms. While the CMC for sodium dodecyl sulfate (i.e., an alkyl sulfonate wherein the alkyl chain has 12 carbon atoms) is reported to be approximately 8.3 mmol in deionized water, the presence of the other components in the polishing composition, and in the surfactant, would be expected to lower the CMC of the surfactant in the polishing composition. Thus, the dodecyl sulfate surfactant is believed to have been present in the polishing composition in an amount above its CMC and able to form micelle-like structures, thereby altering the tantalum removal rate for the polishing composition. In contrast, the alkyl sulfonate surfactants with alkyl chains of up to 10 carbon atoms were believed to be present in the polishing compositions in amounts below their CMC and unable to form the micelle-like structures in those polishing compositions.

The results of this example demonstrate that the removal rate of tantalum is inhibited when the surfactant is in the polishing composition in an amount above its CMC.

### EXAMPLE 2

This example illustrates the effect of the amount of the surfactant in a polishing composition on the rate of removal of a portion, particularly of metal, of a substrate polished with the polishing composition.

A series of polishing compositions was prepared, wherein each polishing composition contained 1 wt. % substantially spherical silica, 0.8 wt. % 9,10-anthraquinone-1,8-disulfonic acid, 500 ppm benzotriazole, and differing amounts of ammonium lauryl sulfate (“ALS”) surfactant. The pH of each polishing composition was adjusted to 2.2 with nitric acid or potassium hydroxide.

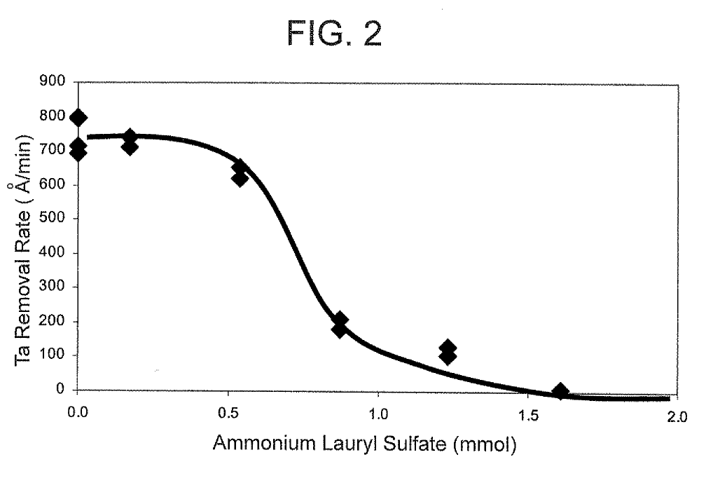

Each polishing composition was used to polish a tantalum wafer under the same conditions as described in Example 1. The rate of tantalum removal (Å/min) was determined for each polishing composition, and the tantalum removal rate for each polishing composition is plotted against the amount of the ammonium lauryl sulfate surfactant in each polishing composition in the graph of FIG. 2.

As is apparent from the results depicted in the graph of FIG. 2, the tantalum removal rate decreased as the surfactant concentration increased in the polishing composition, with a significant inflection point at approximately 0.75 mmol. The CMC of ammonium lauryl sulfate surfactant in the polishing composition is believed to be between 0.5 and 1 mmol.

The results of this example demonstrate that the removal rate of tantalum is inhibited when the surfactant is in the polishing composition in an amount above its CMC.

### EXAMPLE 3

This example illustrates the effect of the amount of surface active compound solubilized by the surfactant in a polishing composition on the rate of removal of a portion, particularly a metal, of a substrate polished with the polishing composition.

A series of eight polishing compositions was prepared, wherein each polishing composition contained different amounts of a nonionic surfactant (PLURONIC™ P103 from BASF), and the surface active compounds tryptophan and benzotriazole (“BTA”). Each polishing composition was prepared by adding the tryptophan, followed by the nonionic surfactant, then stirring the compositions for one hour to complete solubilization. Each composition was then combined with varying amounts of BTA. The pH of each polishing composition was adjusted to 5.8, and then 1 wt. % hydrogen peroxide was added thereto. Polishing was performed using about 10 cm (4 inch) diameter copper wafers on a Logitech polisher with a Cabot Microelectronics Corporation D-100 polishing pad.

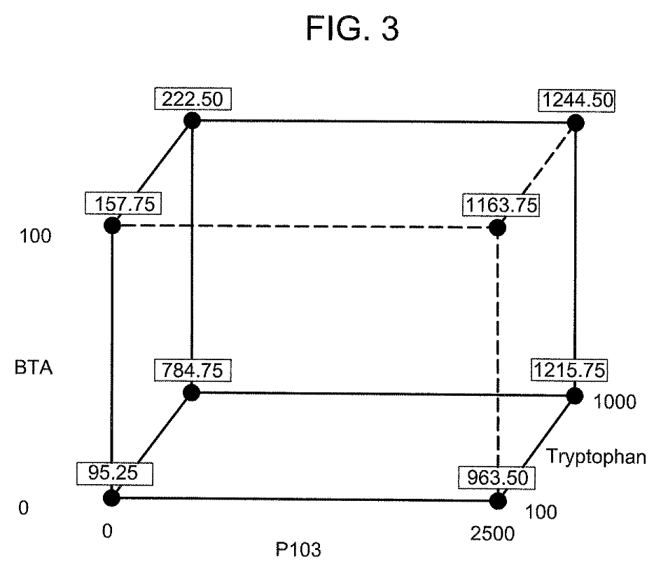

Each polishing composition was used to polish a copper wafer for 60 seconds, utilizing 10.3 kPa (1.5 psi) down force pressure of the copper wafer against the polishing pad, a platen rotational speed of 106 rpm, a carrier speed of 120 rpm, and a polishing composition flow rate of 150 ml/min. The rate of copper removal (Å/min) was determined by the pre-polish and post-polish measurement of the copper wafers using a sheet resistance 4-point probe RS-75 metrology tool (AMAT: Santa Clara, Calif.). FIG. 3 is a graph that depicts the copper removal rate for the polishing composition as a function of the amounts of PLURONIC™ P103 nonionic surfactant (ppm) versus benzotriazole (ppm) versus tryptophan (ppm) in the polishing composition.

As is apparent from the results depicted in FIG. 3, the copper removal rate increased as both the surfactant concentration and amount of hydrophobic surface active compound increased in the polishing composition.

The results of this example demonstrate the correlation between the amount of surface active compound solubilized by the surfactant (e.g., the amount of tryptophan or BTA dissolved within the surfactant micelle) and the characteristics of the polishing composition (e.g., the rate of copper removal achieved by the polishing composition).

### EXAMPLE 4

This example illustrates the solubility of a hydrophobic surface active compound, above its solubility limit, using surfactants in a polishing composition concentrate, and the effect of diluting the polishing composition concentrate on the rate of removal of a portion, particularly a metal, of a substrate polished with the polishing composition.

A control polishing composition was prepared which contained 1 wt. % substantially spherical silica and 400 ppm 2,5-dihydroxy-1,6-benzoquinone (“DHBQ”). DHBQ is an oxidant for tantalum, having a solubility limit close to 400 ppm. The pH of the control polishing composition was adjusted to 2.2.

A polishing composition concentrate was prepared which contained 3 wt. % substantially spherical silica, 1200 ppm DHBQ, and 300 ppm ammonium lauryl sulfate (1.06 mmol). The concentrate was diluted with pH-adjusted water (pH 2.2). Polishing was performed using about 10 cm (4 inch) diameter tantalum wafers on a Logitech polisher with a Polytex polishing pad.

Each polishing composition was used to polish the tantalum wafers under the same conditions as described in Example 1. The control polishing composition was evaluated at the beginning and end of the experiment. The rate of tantalum removal (Å/min) was determined for each polishing composition, and the results are recited in Table 1.

TABLE 1

| Polishing Composition | Ta Removal Rate (Å/min) |
|---|---|
| Control (beginning of testing) | 871, 839 |
| Concentrate Diluted to 1.5 wt. % Solids | 758, 733 |
| Concentrate Diluted to 1 wt. % Solids | 799, 789 |
| Control (end of testing) | 764, 718 |

As is apparent from the results set out in Table 1, the tantalum removal rates were similar between the control polishing composition and the diluted polishing compositions.

The results of this example demonstrate that a polishing composition concentrate can be made where a hydrophobic surface active compound is dissolved above its solubility limit using surfactants. The results of this example also demonstrate that the concentrate can subsequently be diluted to produce a polishing composition to polish a substrate surface.

### EXAMPLE 5

This example illustrates the effect of diluting the polishing composition on the rates of removal of different portions, particularly different metals, of a substrate polished with the polishing composition.

A polishing composition was prepared containing 4 wt. % substantially spherical silica abrasive, 400 ppm ammonium lauryl sulfate (“ALS”) and 1200 ppm 2,5-dihydroxy-1,6-benzoquinone (“DHBQ”) in water (Polishing Composition 5A). This polishing composition then was diluted with increasing amounts of additional water to prepare three other polishing compositions containing 3 wt. % silica abrasive, 300 ppm ALS, and 900 ppm DHBQ (Polishing Composition 5B), 2 wt. % silica abrasive, 200 ppm ALS, and 600 ppm DHBQ (Polishing Composition 5C), and 1 wt. % silica abrasive, 100 ppm ALS, and 300 ppm DHBQ (Polishing Composition 5D). The pH of each polishing composition was adjusted to 2.2. Polishing was performed using about 10 cm (4 inch) diameter copper and tantalum wafers on a Logitech polisher with a Polytex polishing pad.

Each polishing composition was used to polish a copper wafer and a tantalum wafer under the same conditions as described in Example 1. The rate of copper removal (Å/min) and the rate of tantalum removal (Å/min) were determined for each polishing composition, and the results are recited in Table 2.

TABLE 2

| Polishing | Silica | ALS | DHBQ | Cu Removal | Ta Removal |
|---|---|---|---|---|---|
| Composition | (wt. %) | (ppm) | (ppm) | Rate (Å/min) | Rate (Å/min) |
| 5A | 4 | 400 | 1200 | 772 | 23 |
| 5B | 3 | 300 | 900 | 642 | 92 |
| 5C | 2 | 200 | 600 | 646 | 370 |
| 5D | 1 | 100 | 300 | 267 | 573 |

As is apparent from the results set forth in Table 2, as the polishing composition is diluted, the rate of copper removal decreases and the rate of tantalum removal increases. The results of this example demonstrate that the polishing composition is capable of dual-functional polishing. Controlling the removal rates, and thus controlling the polishing, of different portions of the substrate was achieved by varying the dilution of the composition. In this particular case, Composition 5A acts like a copper-specific polishing composition in that it has a high rate of copper removal and low rate of tantalum removal, while Composition 5D acts like a tantalum-specific polishing composition with a relatively high rate of tantalum removal and low rate of copper removal.

### EXAMPLE 6

This example illustrates the effect of a polishing composition, comprising a surfactant in an amount above its CMC, on the rate of removal of a portion, particularly a metal, of a substrate polished with the polishing composition, wherein the surfactant has a charge opposite to the zeta potential charge of the substrate.

A series of base polishing compositions was prepared, wherein each base polishing composition included 5 wt. % fumed alumina. The pH of each polishing composition was adjusted to 7 with potassium hydroxide. A concentrate of 0.355 wt. % cetyltrimethylammonium bromide (“CTAB”) in water also was prepared. The concentrate of CTAB, as well as water, was added in-line to the base polishing compositions to achieve various levels of CTAB concentration at the delivery point (“POU”) on the pad.

Each polishing composition was used to polish about 10 cm (4 inch) diameter tetraethylorthosilicate (“TEOS”) wafers on a Logitech polisher. Each wafer was polished for 60 seconds, utilizing approximately 24.68 kPa (3.58 psi) down force pressure of the substrate against a polishing pad, a platen rotational speed of 110 rpm, a head rotational speed of 102 rpm, and a polishing composition flow rate of 100 ml/min. A Rodel IC1000 polishing pad was utilized. Two wafers were used for each tested polishing composition. The removal rate of material from the TEOS wafers was calculated by the pre-polish and post-polish measurement of the TEOS wafers using a sheet resistance 4-point probe, RS-75 metrology tool, and the results are recited in Table 3.

TABLE 3

| | CTAB | | | TEOS |
|---|---|---|---|---|
| Water Flow | Flow | Alumina | CTAB | Removal Rate |
| (ml/min) | (ml/min) | (wt. %) POU | (wt. %) POU | (Å/min) |
| 0.0 | 0.0 | 5.0 | 0.0 | 1199 |
| 0.0 | 0.0 | 5.0 | 0.0 | 1093 |
| 15.0 | 5.0 | 4.2 | 0.0148 | 1176 |
| 14.0 | 6.0 | 4.2 | 0.0222 | 1076 |
| 12.5 | 7.5 | 4.2 | 0.0222 | 1030 |
| 11.0 | 9.0 | 4.2 | 0.0296 | 264 |
| 10.0 | 10.0 | 4.2 | 0.0296 | 165 |
| 10.0 | 10.0 | 4.2 | 0.0296 | 145 |
| 5.0 | 15.0 | 4.2 | 0.0444 | 235 |
| 0.0 | 20.0 | 4.2 | 0.0592 | 150 |
| 0.0 | 20.0 | 4.2 | 0.0592 | 136 |
| 0.0 | 20.0 | 4.2 | 0.0592 | 122 |

As is apparent from the results set forth in Table 3, the TEOS removal rate decreased as the surfactant concentration increased in the polishing composition, with a significant inflection point between 0.0222 and 0.0296 wt. % CTAB POU.

The results of this example demonstrate that the removal rate of a substrate surface by a polishing composition comprising a surfactant can be reduced by maintaining the concentration of the surfactant in the polishing composition in an amount above its CMC, wherein the surfactant has a charge opposite to the zeta potential charge of the substrate.

### EXAMPLE 7

This example illustrates the effect of diluting a polishing composition, comprising a surfactant in an amount above its CMC and a hydrophobic surface active compound, on the rates of removal of different portions, particularly different metals, of a substrate polished with the polishing composition.

A polishing composition was prepared containing 20 wt. % substantially spherical silica, 0.8 wt. % 9,10-anthraquinone-1,5-disulfonic acid-sodium salt, 0.1 wt. % benzotriazole (“BTA”), 0.1 wt. % ammonium lauryl sulfate (“ALS”) and 0.1 wt. % octanol (as a hydrophobic surface active agent). The pH of the polishing composition was adjusted to 2 with nitric acid (Polishing Composition 7A). This polishing composition then was diluted with increasing amounts of additional water to prepare three other polishing compositions containing 1 part Polishing Composition 7A and 1 part water (Polishing Composition 7B), 1 part Polishing Composition 7A and 3 parts water (Polishing Composition 7C), and 1 part Polishing Composition 7A and 9 parts water (Polishing Composition 7D). Polishing was performed using about 10 cm (4 inch) diameter round tantalum and copper wafers, and about 5 cm (2 inch) diameter round tetraethylorthosilicate (“TEOS”) and Black Diamond (AMAT: Santa Clara, Calif.) (“BD”) wafers on a Logitech polisher with an Epic D100 pad (Cabot Microelectronics, Aurora, Ill.).

Each polishing composition was used to polish each wafer for 60 seconds, utilizing a platen rotational speed of 102 rpm, a head rotational speed of 110 rpm, and a polishing composition flow rate of 100 ml/min. Each polishing composition was used to polish 2 tantalum wafers and 2 copper wafers, utilizing 10.3 kPa (1.5 psi) down force pressure of the wafers against the polishing pad. Each polishing composition was used to polish 3 TEOS wafers, and 3 BD wafers, utilizing 20.6 kPa (3 psi) down force pressure of the wafers against the polishing pad. The average rate of removal (Å/min) of material was determined for each type of wafer with each polishing composition, and the results are recited in Table 4.

TABLE 4

| Polishing | BD Removal | TEOS Removal | Cu Removal | Ta Removal |
|---|---|---|---|---|
| Composition | Rate (Å/min) | Rate (Å/min) | Rate (Å/min) | Rate (Å/min) |
| 7A | 927 | 2,449 | 183 | 320 |
| 7B | 309 | 1,210 | 198 | 164 |
| 7C | 163 | 443 | 214 | 305 |
| 7D | 80 | 115 | 166 | 508 |

As is apparent from the results set out in Table 4, as the polishing compositions are diluted, the TEOS and BD removal rates decrease. The results of this example demonstrate that the removal rate of a hydrophobic substrate surface, such as TEOS or BD, can be impeded by diluting a polishing composition, wherein the polishing composition contains a hydrophobic surface active agent, namely octanol, which has been solubilized using surfactants. Once the polishing composition is diluted to cause the amount of surfactant to be below its CMC, it is believed that octanol is released from the micelle-like structures and is able to impede polishing of the TEOS and BD wafers by partitioning to the hydrophobic TEOS and RD substrate surfaces.

### EXAMPLE 8

This example illustrates the effect of the concentration of surfactant on the surface tension of a composition, and the ability to determine the critical micelle concentration by reference to surface tension measurements.

Individual concentrates of surfactant were prepared containing ammonium lauryl sulfate (“ALS”), cetyltrimethylammonium bromide (“CTAB”), and a mixture of octanol and ammonium lauryl sulfate (“Octanol/ALS”), respectively. Each concentrate was diluted with increasing amounts of water. Two additional compositions were also prepared. The first additional composition was prepared containing 20 wt. % substantially spherical silica, 0.8 wt. % 9,10-anthraquinone-1,5-disulfonic acid-sodium salt, 1000 ppm benzotriazol, 1000 ppm ammonium lauryl sulfate, and 1000 ppm octanol (“ALS/Octanol/Silica”). Nitric acid was added to the ALS/Octanol/Silica composition to adjust the pH to 2. The second additional composition was prepared containing 5 wt. % fumed alumina and 0.335 wt. % cetyltrimethylammonium bromide (“CTAB/Alumina”). Potassium hydroxide was added to the CTAB/Alumina composition to adjust the pH to 7. The two additional compositions were each diluted with increasing amounts of water.

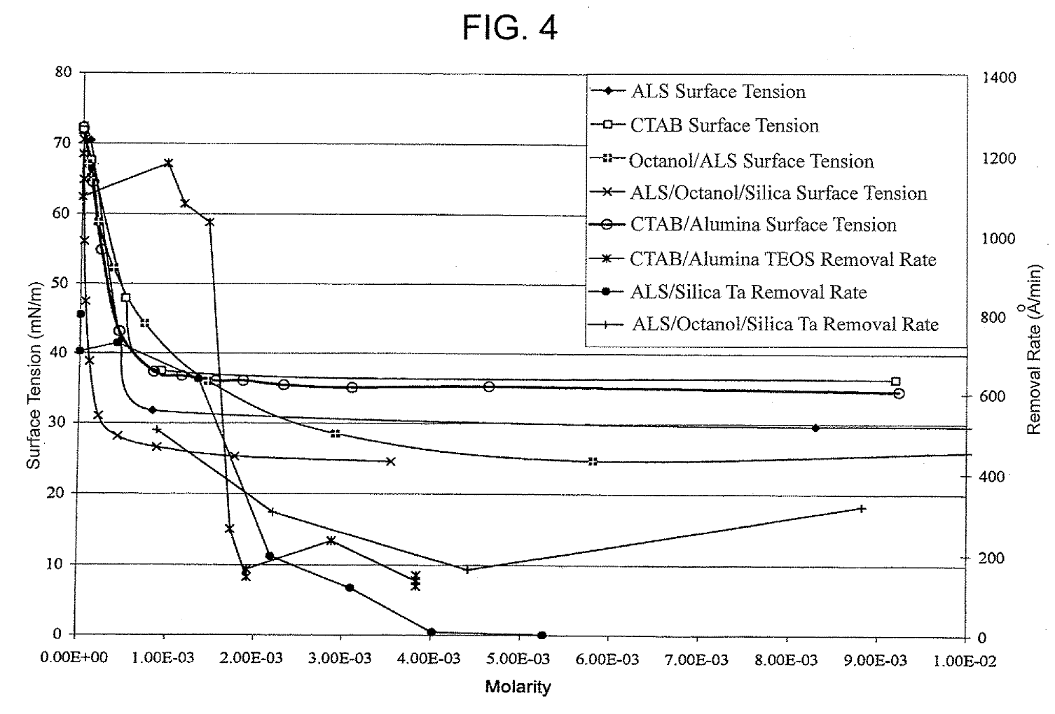

A Kruss K12 platinum plate tensiometer (KRUSS: Matthews, N.C.) was used to measure the surface tensions (mN/m) of each of the compositions at various concentrations of the surfactant ALS or CTAB (molarity) in the compositions, and the results are recited in Table 5. The results are also represented in the graph of FIG. 4, which is a graph that depicts the surface tension (mN/m) against the concentration of surfactant (molarity). FIG. 4 also depicts polishing data as set forth previously in Examples 2, 6, and 7, namely, the rate of tantalum removal (Å/min) using a polishing composition containing ammonium lauryl sulfate and silica (“ALS/Silica Ta Removal Rate”), the rate of tetraethylorthosilicate removal (Å/min) using a polishing composition containing cetyltrimethylammonium bromide and alumina (“CTAB/Alumina TEOS Removal Rate”), and the rate of tantalum removal (Å/min) using a polishing composition containing ammonium lauryl sulfate, octanol, and silica (“ALS/Octanol/Silica Ta Removal Rate”).

TABLE 5

| | Surfactant | Surface | Surface Tension |
|---|---|---|---|
| | Concentration | Tension | Standard Deviation |
| Composition | (M) | (mN/m) | (mN/m) |
| ALS | 0.0000E+00 | 72.6 | 0 |
| | 8.3000E−05 | 70.47 | 0.01 |
| | 4.5650E−04 | 41.88 | 0.09 |
| | 8.3000E−04 | 31.78 | 0.95 |
| | 8.3000E−03 | 29.64 | 0.07 |
| | 8.3000E−02 | 30.79 | 0.09 |
| | 1.0600E−01 | 31.39 | 0.01 |
| CTAB | 0.0000E+00 | 72.36 | 0.02 |
| | 0.0000E+00 | 71.86 | 0.01 |
| | 9.2000E−05 | 67.66 | 0.04 |
| | 5.0600E−04 | 47.96 | 0.07 |
| | 9.2000E−04 | 37.47 | 0.09 |
| | 9.2000E−03 | 36.33 | 0.01 |
| Octanol/ALS | 4.5313E−05 | 67.07 | 0.07 |
| | 9.0625E−05 | 65.12 | 0.06 |
| | 1.8125E−04 | 58.88 | 0.05 |
| | 3.6250E−04 | 52.28 | 0.05 |
| | 7.2500E−04 | 44.31 | 0.03 |
| | 1.4500E−03 | 35.99 | 0.1 |
| | 2.9000E−03 | 28.52 | 0.03 |
| | 5.8000E−03 | 24.73 | 0.03 |
| | 1.1600E−02 | 26.62 | 0.1 |
| ALS/Octanol/Silica | 0 | 72.43 | 0.02 |
| | 2.9688E−05 | 67.07 | 0.07 |
| | 5.9375E−05 | 65.12 | 0.06 |
| | 1.1875E−04 | 58.88 | 0.05 |
| | 2.3750E−04 | 52.28 | 0.05 |
| | 4.7500E−04 | 44.31 | 0.03 |
| | 9.5000E−04 | 35.99 | 0.1 |
| | 1.9000E−03 | 28.52 | 0.03 |
| | 3.8000E−03 | 24.73 | 0.03 |
| | 7.6000E−03 | 24.62 | 0.1 |
| | 0 | 72.46 | 0.01 |
| CTAB/Alumina | 0.00E+00 | 72.24 | 0.01 |
| | 1.15E−04 | 64.53 | 0.04 |
| | 2.25E−04 | 54.89 | 0.08 |
| | 4.40E−04 | 43.17 | 0.07 |
| | 8.40E−04 | 37.32 | 0.03 |
| | 1.15E−03 | 36.76 | 0.02 |
| | 1.54E−03 | 36.02 | 0.05 |
| | 1.85E−03 | 36.07 | 0.05 |
| | 2.31E−03 | 35.46 | 0.03 |
| | 3.08E−03 | 35.08 | 0.03 |
| | 4.62E−03 | 35.29 | 0.13 |
| | 9.24E−03 | 34.61 | 0.07 |
| | 0.00E+00 | 72.09 | 0.02 |

As is apparent from the results set forth in Table 5 and depicted in FIG. 4, as the surfactant concentration increases there is a decrease in the surface tension. In addition, the results depicted in FIG. 4 show a correlation between the polishing data and the surface tension measurements for compositions comprising the same surfactant. This correlation is evidenced by the close proximity of the inflection point in a curve for the rate of substrate removal to the inflection point in a curve measuring surface tension where the two curves represent compositions comprising the same surfactant. For example, the inflection point in the curve for the ALS/Octanol/Silica Ta removal rate is in close proximity to the inflection point in the curve for the ALS/Octanol/Silica surface tension.

The results of this example demonstrate that surface tension measurements can be used as a reference to determine the critical micelle concentration. In particular, the surface tension decreases with increasing amounts of surfactant until near the critical micelle concentration where the surface tension measurement nearly reaches a constant value. This is represented by a linear region in the slope of the curve for surface tension measurement. In addition, the rate of substrate removal is lower when using a polishing composition having a surface tension measurement within this linear region as compared to the rate of substrate removal when using the same polishing composition having a surface tension measurement in a region of the curve where the surface tension is increasing. Therefore, an inflection point in the curve for surface tension measurement, located between these two regions, can be used as a reference point that approximates the critical micelle concentration of the polishing composition.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A polishing composition comprising
(a) an abrasive, wherein the abrasive is present in an amount of 18 wt. % or more of the polishing composition,
(b) an aqueous medium,
(c) a surfactant, wherein the surfactant is present in an amount above its critical micelle concentration, and
(d) a hydrophobic surface active compound.

2. The polishing composition of claim 1, wherein the abrasive is present in an amount of 18 wt. % to 30 wt. % of the polishing composition.

3. The polishing composition of claim 1, wherein the abrasive is colloidally stable in the polishing composition.

4. The polishing composition of claim 1, wherein the surfactant comprises a sulfonate group.

5. The polishing composition of claim 1, wherein the hydrophobic surface active compound is selected from the group consisting of azole compounds and amino acids which satisfy the formula H₂N—CR¹R²COOH, wherein R¹ and R² are hydrogen, C₁-C₃₀ alkyl, or C₆-C₃₀ aryl groups wherein the aryl groups optionally comprise one or more hetero atoms N, S, O, or a combination thereof, R¹ and K do not contain a total of less than one carbon, and R¹ and R² do not contain any charged groups.

6. The polishing composition of claim 1, wherein the hydrophobic surface active compound is selected from the group consisting of octanol and compounds having a log K_{OW} above about 0.

7. A method of using a polishing composition, which method comprises:
(i) providing a polishing composition comprising:
(a) an abrasive, wherein the abrasive is present in an amount of 18 wt. % or more of the polishing composition,
(b) an aqueous medium, and
(c) a surfactant, wherein the surfactant is present in an amount above its critical micelle concentration, and
(ii) diluting the polishing composition.

8. The method of claim 7, wherein the abrasive is present in an amount of 18 wt. % to 30 wt. % of the polishing composition prior to diluting the polishing composition.

9. The method of claim 7, wherein the abrasive is colloidally stable in the polishing composition prior to diluting the polishing composition.

10. The method of claim 7, wherein the surfactant comprises a sulfonate group.

11. The method of claim 7, wherein the polishing composition is free of a complexing agent.

12. The method of claim 7, wherein the polishing composition further comprises a hydrophobic surface active compound.

13. The method of claim 12, wherein the hydrophobic surface active compound is selected from the group consisting of azole compounds and amino acids which satisfy the formula H₂N—CR₁R₂COOH, wherein R₁ and R₂ are hydrogen, C₁-C₃₀ alkyl, or C₆-C₃₀ aryl groups wherein the aryl groups optionally comprise one or more hetero atoms N, S, O, or a combination thereof, R₁ and R₂ do not contain a total of less than one carbon, and R₁ and R₂ do not contain any charged groups.

14. The method of claim 12, wherein the hyrdophobic surface active compound is selected from the group consisting of octanol and compounds having a log K_{OW}, above about 0.

15. The method of claim 7, which method further comprises contacting a substrate with the polishing composition while the surfactant is present in the polishing composition in an amount above its critical micelle concentration to abrade a first portion of the substrate and thereby polish the substrate.

16. The method of claim 15, wherein the first portion of the substrate comprises copper.

17. The method of claim 15, wherein the surfactant interacts with a second portion of the substrate so as to inhibit the removal of the second portion of the substrate.

18. The method of claim 17, wherein the second portion of the substrate comprises tantalum.

19. The method of claim 17, wherein diluting the polishing composition is limited so that the amount of surfactant remains above its critical micelle concentration.

20. The method of claim 17, wherein the polishing composition has a pH higher than an isoelectric point of the second portion of the substrate, and the surfactant is cationic.

21. The method of claim 17, wherein the polishing composition has a pH lower than an isoelectric point of the second portion of the substrate, and the surfactant is anionic.

22. The method of claim 17, wherein the surfactant has a charge opposite to a zeta potential charge of the second portion of the substrate.

23. The method of claim 17, which method further comprises contacting the substrate with the polishing composition while the surfactant is present in the polishing composition in an amount below its critical micelle concentration to abrade the second portion of the substrate and thereby polish the substrate.

24. The method of claim 23, wherein the polishing composition further comprises an oxidant, and wherein a decrease in the concentration of the oxidant reduces the rate of removal of the first portion of the substrate.

25. The method of claim 7, wherein diluting the polishing composition causes the amount of surfactant to be below its critical micelle concentration prior to contacting the substrate with the polishing composition.

26. The method of claim 25, which method further comprises contacting the substrate with the polishing composition while the surfactant is present in the polishing composition in an amount below its critical micelle concentration to abrade a portion of the substrate and thereby polish the substrate.

27. The method of claim 26, wherein the portion of the substrate comprises tantalum.

28. The method of claim 26, wherein the polishing composition further comprises an oxidant, and wherein a decrease in the concentration of the oxidant reduces the rate of removal of a second portion of the substrate.

29. The method of claim 28, wherein the second portion of the substrate comprises copper.

30. The method of claim 26, which method further comprises:
(i) providing a second polishing composition comprising:
(a) an abrasive, wherein the abrasive is present in an amount of 18 wt. % or more of the polishing composition, and
(b) an aqueous medium, and
(ii) contacting the substrate with the second polishing composition to abrade a second portion of the substrate and thereby polish the substrate.

31. The method of claim 30, wherein the second portion of the substrate comprises copper.
